(19) United States
(12) Patent Application Publication
(10) Pub. No.: US 2015/0339608 A1
(43) Pub. Date: Nov. 26, 2015

(54) METHOD AND SYSTEM FOR EMPLOYEES TO ENHANCE DEMONSTRATE AND ADHERE TO ORGANIZATION VALUES AND PERSONAL BELIEFS

(71) Applicant: Jadav Manirao SAMPATH, Bangalore (IN)

(72) Inventor: Jadav Manirao SAMPATH, Bangalore (IN)

(21) Appl. No.: 14/616,930

(22) Filed: Feb. 9, 2015

(30) Foreign Application Priority Data
May 23, 2014 (IN) 2564/CHE/2014

(51) Int. Cl. G06Q 10/06

(52) U.S. Cl. CPC G06Q 10/0637

(57) ABSTRACT

The embodiments herein disclose a method and system for employees to enhance demonstrate and adhere to one or more organization values and personal beliefs. A user signs into the value adherence system and is assigned an activity. The response of the user and the validation of two reviewers have to be taken into consideration to signify completion of an activity. Several levels and activities once completed indicate demonstration of a value and manifestation of personal beliefs.

The present application claims priority to co-pending India patent application serial no. 2564/CHE/2014, filed on May 23, 2014.

### TECHNICAL FIELD

Embodiments of the disclosure relate to organizational values, vision, mission statement and strategies and more particularly to using value-building tools to assist employees to understand, adhere to and demonstrate an organization's values.

### BACKGROUND

In the modern business era, effective organizations are aware of the need to identify and develop a clear, concise and shared meaning of value/beliefs, priorities and direction so that every employee understands and can contribute. Once defined, values impact every aspect of an organization. Organizations must have clear values and principles in order to be successful in building their culture. In order to be meaningful, these values and principles should be expressed to employees in a manner that is clear to them and encourages them to demonstrate those values in their day-to-day operations.

Organizations continue to experience mergers, acquisitions, downsizing, rightsizing, new visions, new directions, new products, and new services and so on. These scenarios present challenges for the organization, its employees and its customers. As organizations struggle to meet these challenges, authorities develop their strategic plans, re-think their vision and mission and try to engage their staff in the implementation of the value-based factors.

However, the implementation of these initiatives usually meets with some kind of resistance from the staff as they usually find them uninteresting and preachy. Some employees also feel such attempts as adding another tedious task in their daily work schedule and more importantly these initiatives rarely consider how the organization's culture will change for employees.

To successfully manage the organizational cultural impacts of these changes it is necessary to implement value adherence management process where it is important for all levels of staff to fully incorporate the change in everything they do.

In an exemplary method, a method of analyzing an organization's personnel and material resource data to provide options to maximize efficiency is disclosed. The method is contemplated to be able to be incorporated into a computer language such that decision options can be provided to authorities in a real time basis. Further analysis of an organization is reduced to the organization's readiness and preparedness to perform designated tasks based on standardized capabilities. The demerit of this method is that it is restricted to monitoring decision making capabilities of the employees.

In another exemplary method, a method and system is disclosed for determining measures being taken across an organization based on the performance specifications of a cross-level-value chain. The method includes defining the value chain where the value chain defines various strategic business goals such as customer goals, financial goals and differentiator goals of the organization. The system includes a user interface which is configured for designing the goals and projects required at each level and stage of a value-chain. The system includes a controller which in turn includes a goal setting module, a simulation module, and an optimization module. The demerits of this method are that the user interface designs the same goal and values for every employee and organization irrespective of their vision and value statement.

Existing methods are also not capable of identifying various bottleneck areas in the business strategies. Additionally, these existing systems also fail to formulate and implement the business strategies for large organizations where the complexity of the business strategies increases with an increase in the number of employees, Lines of Businesses (LOBs) and geographies.

In light of the above, there appears to be a need for a thorough and comprehensive method and system to enhance, demonstrate, and bring about adherence to organization values and personal beliefs.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is an block diagram view of a social network depicting the components in a Value adherence system, according to embodiments as disclosed herein;

FIG. 2 is a block diagram depicting the modules in a controller of the value adherence system, according to embodiments as disclosed herein;

FIG. 3 is a detailed block diagram illustrating various module in the second sub-system such as that of FIG. 1, according to the embodiments as disclosed herein; and

FIG. 4 illustrates a computing environment implementing the application, according to embodiments disclosed herein.

### SUMMARY

Accordingly, the embodiments herein provide a method for understanding, adhering, and demonstrating at least one value and at least one personal belief of at least one individual, where the method includes compiling a value based questionnaire to determine responses from the individual and designing the value to articulate a vision of an organization, wherein the value is assessed on a periodical basis.

Further, the method includes processing an input received from one or more users answering the questionnaire to determine at least one result in one or more key areas and simulating a game based environment for one or more users to provide said responses to an activity at an pre-determined level;

Further more, the method includes identifying at least one of outcome, input and moderating parameters to realize the value, storing and archiving data retrieved from the users; and providing results in one or more forms to determine at least one of a remedial measure, training programs, suggestions and feedback.

Accordingly, the embodiments herein provide a computer implemented system for understanding, adhering, and demonstrating at least one value and at least one personal belief of at least one individual, where the system comprises an user interface to formulate and design a detailed business strategy, wherein said detailed business strategy is based on one or more values defined by an organization and a controller to control and co-ordinate functioning and processing of the system, wherein the controller gauges performances of a process to ensure a high probability of achieving said business goal

Further, the system comprises a rule engine to compute at least one of measures, statistics and one or more requisite actions; and a review module to calculate a degree of control of said process, wherein the review module is configured to offer at least one of feedback and suggestions.

### DETAILED DESCRIPTION OF THE EMBODIMENTS

The present disclosed and claimed subject matter provides a system and method that can be utilized with a variety of different client devices, including but not limited to desktop computers and mobile devices such as PDA's, smart phones, cellular phones, tablet computers, and laptops. Thus, while the disclosed and claimed subject matter may be embodied in many different forms, the drawings and discussion are presented with the understanding that the present disclosure is an exemplification of the principles disclosed herein and is not intended to limit to any of the disclosed embodiments illustrated.

The following detailed description is intended to provide example implementations to one of ordinary skill in the art, and is not intended to limit the disclosed and claimed subject matter to the explicit disclosure, as one of ordinary skill in the art will understand that variations can be substituted that are within the scope of the subject matter as described and claimed.

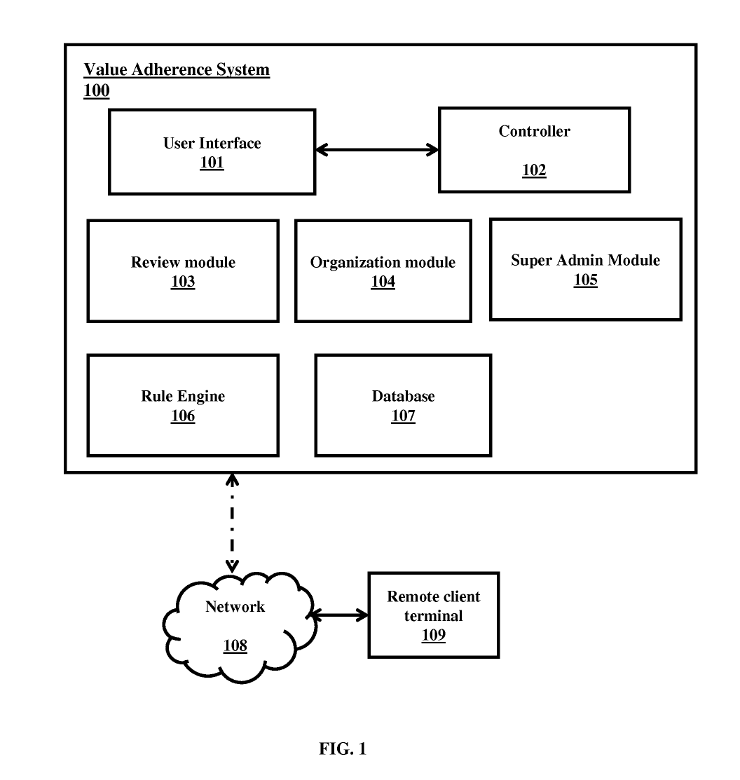

FIG. 1 is a block diagram depicting the components in a Value adherence system, according to embodiments as disclosed herein. As depicted in FIG. 1 the Value Adherence System 100 comprises of a User Interface 101, a Controller 102, a Review module 103, an Organization module 104, a Super admin module 105, a Rule Engine 106 and a Database 107. The Value adherence system 100 is connected to a suitable network such as the internet. The Value adherence system 100 can also be run offline if the user has installed the system 100.

In an embodiment the Value adherence system 100 can be run on any device that is connected to a suitable network 106. The device can be a handheld device such as a smart phone, tablet, Personal Digital Assistant (PDA) and the like or the device can be embedded in a portable computer (Laptop and the like).

Values and Principles help to identify the culture that an organization establishes for how its employees will operate within its new environment. They identify the behaviors and actions that are required to successfully fit into its culture. All levels of employees have a responsibility to understand these values and principles and to demonstrate them in their day-to-day actions and interactions. Values are fundamental beliefs. The strengths of the organization will be built on these core values.

Principles are guides to behavior. They guide how employees live their values and influence the results they achieve. The User Interface 101 in the Value Adherence System 100 is configured for designing the goals and projects required at each level and stage of a value-chain. The User Interface 101 enables a user of an Organization to formulate/design a detailed business strategy in terms of the values defined by the organization. The business strategy is defined while keeping in mind the organizations' mission statement. The user of an organization may be an organizational leader, senior executive, or an employee at any level in the organizational hierarchy. The value-chain includes one or more sub-processes (or activities) which define various strategic business goals of an organization. These goals are defined by the top management of the organization, such as Chairman, and Chief Executive Officer (CEO), Executive Vice Presidents, and Senior Vice Presidents. Example of various values may include, but are not limited to, ambition, competency, individuality, equality, integrity, service, responsibility, accuracy, respect, dedication, diversity, improvement, enjoyment/fun, loyalty, credibility, honesty, innovativeness, teamwork, excellence, accountability, empowerment, quality, efficiency, dignity, collaboration, stewardship, empathy, accomplishment, courage, wisdom, independence, security, challenge, influence, learning, compassion, friendliness, discipline/order, generosity, persistency, optimism, dependability, flexibility.

In an embodiment, the results, desired outcomes, input and moderating parameters are input by the user using the user interface 101.

The Controller 102 controls and co-ordinates the functioning and processing of the value adherence system. The Controller 102 gauges the performance of the process which is simulated in one or more scenarios to ensure a high probability of achieving strategic business goals in spite of setbacks. The Rule Engine 106 works in collaboration with the Controller 102 to compute measures, statistics that compare measures with targets, and the requisite actions that are intended to be necessary and sufficient to realize the value adherence development with respect to the employees.

The Review Module 103 helps peers or colleagues rate the value adherence of a particular employee in a certain time span. The Review Module 103 calculates the degree to which the processes are in control and are likely to realize the vision statement and missions. The Review module 103 offers feedback and suggestions in forms ranging from daily reminders, story card based comment, an e-mail offering advice and the like.

The Organization module 104 is the engine of the Value Adherence System 100 which provides an online platform for organizations to help and enable employees to understand and demonstrate organization values. The Organization module 104 is also configured to help employees identify and understand their personal values and beliefs which in turn enable employees to demonstrate personal values.

Additional functioning of the Organization module 104 is to assist employees in understanding the alignment between individual and organization values. The Organization module 104 also tracks the extent to which one or more employees adhere to organization values and to recognize those demonstrated organized values.

Being the engine of the value adherence system 100, the Organization module 104 provides an online platform for one or more employees to identify and understand the values that they would prefer to live by and in furtherance help them demonstrate their chosen set of values. The special purpose of the Organization module 104 is to make the entire process of demonstrating or adhering to values, engaging, fun, and game-based.

In an embodiment, the online platform needs to be supported on a plurality of communication devices such as PC, tablet, mobile device and so on.

In another embodiment, the online platform supported on the Organization module 104 must be quickly and easily replicable if a micro site has to be created for an organization which requires the services.

The Organization module 104 works in conjunction with the Super admin module 105. A user may sign into the proposed system with the Super admin module 105. The Super admin module 105 helps create and maintain user accounts for employees in the organization. The Super admin module 105 helps map organization beliefs to one or more organization values and additionally it adds activities to each organization's value-belief combination.

In a preferred embodiment, the Super admin module 105 is on an auto-pilot mode where the value adherence system 100 automatically assigns the same value or different values to employees. The value adherence system 100 is configured to be developed in a way that if an employee completes one level of a value, the super admin module 105 can assign either the next level of the same value or the first level of another value.

The database 107 stores the prerequisite values and every additional parameter required for conducting a test of the value adherence system 100. In particular, the database 107 uploads a list of activities for a specific value-belief combination and also comprises a list of values an individual wants to live by so that it helps in smooth functioning of an interactive experience. The database 107 is also configured to store the results, user-related data and other relevant learning material.

In an embodiment, the Value Adherence System 100 can be run on any device that is connected to a suitable network 108 which in turn is connected to a remote client terminal 109.

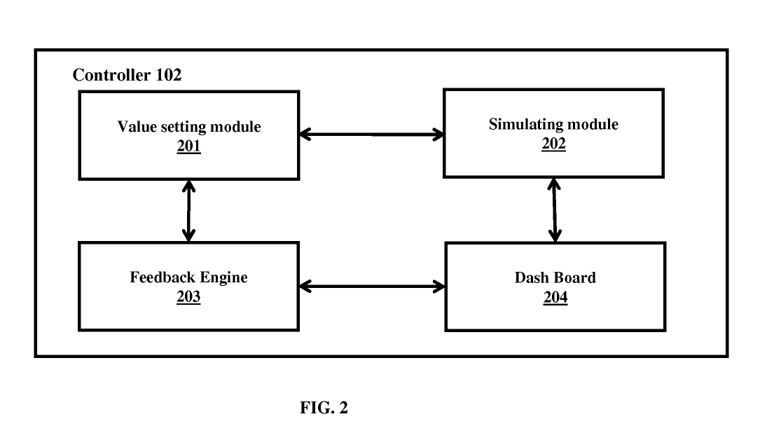

FIG. 2 is a block diagram depicting the modules in a controller of the value adherence system, according to embodiments as disclosed herein. As depicted in FIG. 2, the Controller 102 comprises of modules such as a Value Setting Module 201, a Simulating Module 202, a Feedback Engine 203, and a Dash Board 204. The Value setting module 201 works in tandem with the Organization module 104 and the Super admin module 105. The Value setting module 201 assists an administrator to sign into the value adherence system 100. The Value setting module 201 assists in adding a plurality of general values that employees can choose to demonstrate based on their own orientation and also one or more general beliefs are added that employees can choose to pursue.

The Simulating module 202 creates a game based environment with the help of the User Interface 101 which is easy to use and an interactive user friendly system. The Simulating Module 202 leverages one or more simulation methodologies to provide a new set of values for every new activity and for every level completed. Every activity is based on the core values defined by an organization in a value-centric manner. For example, each activity may have a plurality of questions, surveys, picture-recognitions and other related game based tasks which may range from including but not limited to 10 to 30 and time-lines to complete the test varying from 10 to 30.

The Simulating module 202 also produces estimates that a team can evaluate as to whether an employee is able to progress to the next level or is considered fit for re working on the activities prescribed in the same level despite several failed attempts.

The Feedback Engine 203 calculates the degree to which the processes are in control and likely to realize values in the value adherence system 100. The Feedback Engine 203 includes major quantitative techniques to quantify various inputs fed by the user. By working in tandem with the Rule Engine 106, the Feedback Engine 203 evaluates the scores.

In an embodiment, an activity is assigned corresponding to an Organization value which is assigned to a individual. The individual completes the activity and chooses 2 peers as reviewers. If both reviewers approve the activity, the activity is considered COMPLETE. Even if one of the reviewers rejects, that activity is considered FAILED and another activity is assigned to the individual. When an individual completes all activities in a level, they are moved to the next level.

Individuals are assigned BADGES when they complete every level in a Value and also when they complete all the levels in a Value.

For example, reviewers or senior leaders are able to get a report of the weakest process capabilities in the firm and the degree of the lack or increase in value adherence. However, certain leaders and reviewers may not be able to access all the results or reports which depend on how the value adherence system 100 is configured.

The Dash Board 204 is an interactive display forum built on the value adherence system 100. On the dashboard 204 details and information such as values and corresponding beliefs and activities assigned to them can be displayed.

In an embodiment, the values may be automatically assigned by the value adherence system 100 or manually by an administrator. The Dashboard 204 also displays matches between personal values and organization values. Further, the Dashboard 204 also considers request from peers to mark the completion/non-completion of an activity which includes pending activities and expected completion dates.

In an embodiment, there includes one or more feeds and updates based on other employee activities which may include one or more generic feeds or only those associated with the employees.

The Dashboard 204 also permits users to like/dislike the feeds/updates and to pass comments. Likewise, a user may search for and view other's employee's dashboards. Further, the user is provided with an option of adding employees they want to follow. The Dashboard 204 is also configured to receive alerts on one of dashboard/e-mail/and messages based on the following conditions:
The value adherence system 100 is assigned with a value/activity.
The value adherence system 100 is also configured to receive requests from peers to mark the completion of their activity.

In an embodiment, the Dashboard 204 permits users to sign into the value adherence system with an Individual role. That is, catering to personal values and beliefs. The Dashboard 204 assists users to choose values they want to live by and shed values they do not want to imbibe which helps to create an interactive (say animation-driven) experience.

In another embodiment, a basket is preloaded with values and a user is provided with an option of picking a value from the basket. In case a user likes a value, they may add it on a value tree (which is similar to a value chain). The user can click the value to see the available activities and this helps choose one or more activities.

In case a user does not like a value, they have an option of dropping into a trash can. As the user continues to drop values, they get reminders from the dashboard 204 to assist them in staying away from those values.

### Exemplary Embodiment

An employee logs into the Value adherence system 100. An employee can log in only if he or she has a valid user account. The user account in the Value Adherence System 100 may be on a subscription basis or free of cost.

An employee can use the remote client terminal 109 to log into the value adherence system 100. The system 100 can be configured to work either online or offline. The remote client terminal 109 can be any device configured to support the value adherence system 100 such as a mobile device, tablet, PC, PDA and so on.

The User Interface 101 supported by the Dashboard 204 displays the activity assigned for the day and the employee inputs his responses. These responses have to be validated by a reviewer and in case they are not validated the employee continues to stay in the same level and cannot proceed further.

For example, if an employee is assigned a value by the Value Adherence System 100 such as meeting client requirements, then the responses entered by the employee have to be validated and given a go ahead by the other employees who are reviewing the responses. If the responses are validated, then the employee proceeds to the next level.

Every level has an increased level of difficulty and a reducing time-line. This process ensures that the employee has mastered one level before moving to the next.

In an embodiment, all the values are fed to the super admin module 105. The values are aligned based on the inputs received from top level executives of an organization. Once an activity is completed a badge will be assigned and for every level completed a badge or a tag will be issued to denote completion of a level or an activity.

In another embodiment, if a user completes 3 levels of a value, then this signifies that the user has demonstrated all the levels and a particular badge is assigned. Further, one or more activities are assigned to each level since no two persons should ideally undergo the same activity. Since every employee is usually provided with an account, the Value Adherence System 100 pumps out activities as soon as the previously assigned activity completes/fails/expires. This process is facilitated by the randomization logic ware provided by the Value Adherence System 100.

While undergoing the activities, the dashboard 204 displays the list of tasks related to the activities and badges. In an embodiment, every individual is provided with only one activity at a time. An employee also has an option to choose reviewers and both the reviewers have to acknowledge completion of an activity. However, the reviewers chosen for one activity will not be the same for the next activity. The Review module 103 is configured to set a waiting period for the reviewers to provide their feedback. In case the reviewers do not provide feedback with the scheduled waiting period, they may be assigned one or more activities at the same level. All the inputs received from the user and the review feedback will be stored in the database 107.

In an embodiment, videos, images story cards and so on facilitate manifestation of a value. The principal feature of the invention is to encourage the employee to understand and demonstrate organization's values.

In another embodiment the Value Adherence System 100 is designed to influence employee's belief and values and to manifest their intentions into actions. The feedback engine 203 assists users to follow each other.

In an embodiment, once an assigned activity is completed by an employee, a new activity will be automatically assigned.

In an exemplary preferred embodiment, the Value Adherence System 100 also assists an individual to help realize his personal values and beliefs. For example, an individual would like to contribute to the society by donating blood or pledging eyes but has so far not performed any measures to move further. In this particular case, once the individual chooses a particular set of values, the dashboard 204 reminds or urges an individual by sending notifications on a timely basis to remind him to manifest his personal values and beliefs into reality. The notifications may be in form of RSS feeds, e-mail, story card, images and so on. This process includes no reviewing and monitoring of the activity.

Essentially, the present invention realizes a framework to help employees adhere to value adherence and manifestation of personal beliefs.

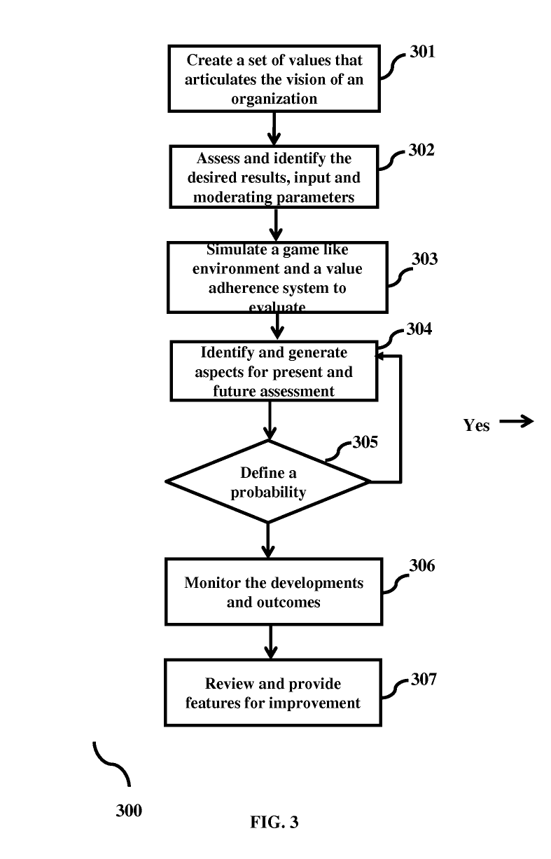

FIG. 3 is a flow diagram depicting the process flow in the value adherence system, according to embodiments as disclosed herein. As depicted in FIG. 300, initially a cross-functional team is created to oversee and guide the development of the Values and Principles. This cross-functional team will be responsible for the management of these process steps. At step 301 a set of values that articulates the vision of an organization is emphasized. Brainstorm words can be used to identify the actions and behaviors that employees will demonstrate that indicate a focus on quality, customers, other employees, management, and so on.

Further, these categories of values are Organized into categories (fundamental beliefs that become the essence of the organization and cherished by all employees) and Principles (guides to behaviours that demonstrate how employees demonstrate the values and therefore influences the results the organization achieves).

Once an employee uses the value adherence system 100 and inputs the desired responses, at step 302 a level of complexity is set for each activity on a three point scale where a time line is also set by the organization module 104 for completing this activity. The Organization module 103 assesses and identifies the desired results, inputs and moderating parameters.

In an embodiment, there are a few general values that employees can choose to demonstrate based on their own orientation. Usually one or more documents/audios/videos/images for each value will been uploaded. Every activity that an employee chooses has a certain level of complexity and a certain time line. The activity can be set to be seen/chosen by users if they have not completed an activity from a lower level and so on.

Further, labels such as text or image are used to be displayed against employees to complete a specific level of activities.

At step 303, the activities are simulated in a game based environment manner and the employee's adherences to values are assessed.

Behavioral descriptions are developed (what behaviours and/or actions will an individual display that demonstrates their full realization of a Value or Principle) and attached to each Value or Principle.

At step 304, one or more aspects based on the inputs tendered by employees are identified for present and future assessment.

A 360-Degree Feedback instrument of the review module 103 will be used by all employees to demonstrate their actual behaviors benchmarked against the expected behaviors.

In an embodiment, the value and adherence system 100 is also configured to provide value adherence to employees on aspects such as Punctuality and Timeliness, Quality of Products and Services, Presentation, functionality, choice, value, speed, timeliness, suitability, repeatability, reliability, life span, repeatability, courtesy, friendliness, and the like. Further valuations can be performed in terms of forms, files, procedures, reports, performance evaluations, equipment, training, recruitment, orientations, communications, and so on.

Furthermore, a probability is defined where developments and outcomes are monitored by the review module 103 at step 306. This probability helps identify the number of employees who are capable of adequate value adherence and also suggests a set of new activities to be performed on a random basis with every employee.

Finally, at step 307 a complete and exhaustive review is performed to provide one or more features for development of the overall process and the employee using the value adherence system 100. The various actions in method 300 may be performed in the order presented, in a different order or simultaneously. Further, in some embodiments, some actions listed in FIG. 3 may be omitted.

Thus overall, it can be seen that the embodiments provide an end to end solution for individual and group assessment and also promote analysis and development in almost every sphere of human potential.

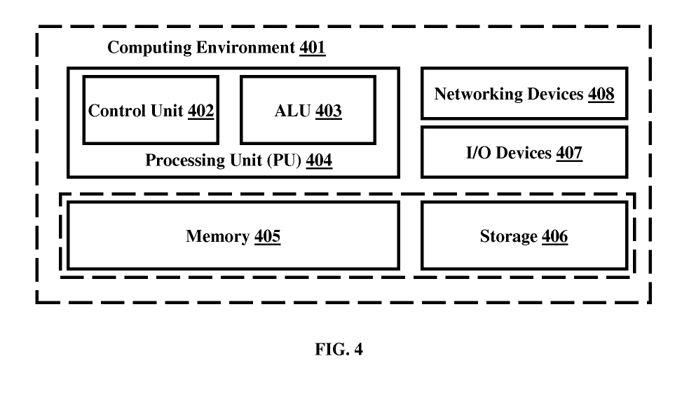

FIG. 4 illustrates a computing environment implementing the application, according to embodiments disclosed herein. As depicted the computing environment comprises at least one processing unit that is equipped with a control unit 402 and an Arithmetic Logic Unit (ALU) 403, a memory 405, a storage unit 406, plurality of networking devices 408, and a plurality Input output (I/O) devices 407. The processing unit 404 is responsible for processing the instructions of the algorithm. The processing unit 404 receives commands from the control unit 402 in order to perform its processing. Further, any logical and arithmetic operations involved in the execution of the instructions are computed with the help of the ALU 403.

The overall computing environment can be composed of multiple homogeneous and/or heterogeneous cores, multiple CPUs of different kinds, special media and other accelerators. The processing unit 404 is responsible for processing the instructions of the algorithm. The processing unit 404 receives commands from the control unit 402 in order to perform its processing. Further, any logical and arithmetic operations involved in the execution of the instructions are computed with the help of the ALU 403. Further, the plurality of process units may be located on a single chip or over multiple chips.

The algorithm comprising of instructions and codes required for the implementation are stored in either the memory unit or the storage or both. At the time of execution, the instructions may be fetched from the corresponding memory and/or storage, and executed by the processing unit.

In case of any hardware implementations various networking devices or external I/O 407 devices may be connected to the computing environment to support the implementation through the networking unit and the I/O device unit.

The embodiments disclosed herein can be implemented through at least one software program running on at least one hardware device and performing network management functions to control the elements. The elements shown in FIG. 1 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for understanding, adhering, and demonstrating at least one value and at least one personal belief of at least one individual, said method comprising:
compiling a value based questionnaire to determine responses from said individual;
designing said value to articulate a vision of an organization, wherein said value is assessed on a periodical basis;
processing an input received from one or more users answering said questionnaire to determine at least one result in said one or more key areas;
simulating a game based environment for one or more users to provide said responses to an activity at an pre-determined level;
identifying at least one of outcome, input and moderating parameters to realize said value;
storing and archiving data retrieved from said users; and
providing results in one or more forms to determine at least one of a remedial measure, training programs, suggestions and feedback.

2. The method as claimed in claim 1, wherein said method further comprises completion of said activity at said predetermined level.

3. The method as claimed in claim 1, wherein said method further comprises a basket provided with an option of picking said value and removing said value.

4. The method as claimed in claim 1, wherein said method includes reviewing at least one of individual or group effectiveness with one or more reviewers to assess completion of said activity at said pre-determined level.

5. The method as claimed in claim 1, wherein said completion of activity is determined after complete validation of said one or more reviewers.

6. The method as claimed in claim 1, wherein a notification is sent to the user to remind of one or more personal values and beliefs to adhere, wherein said one or more personal values and beliefs are chosen by the user.

7. A computer implemented system for understanding, adhering, and demonstrating at least one value and at least one personal belief of at least one individual, said system comprising:
an user interface to formulate and design a detailed business strategy, wherein said detailed business strategy is based on one or more values defined by an organization;
a controller to control and co-ordinate functioning and processing of the system, wherein said controller gauges performances of a process to ensure a high probability of achieving said business goal;
a rule engine to compute at least one of measures, statistics and one or more requisite actions; and
a review module to calculate a degree of control of said process, wherein said review module is configured to offer at least one of feedback and suggestions.

8. The system of claim 7, wherein said system further comprises a organization module to assist said users to demonstrate said value between at least one of individual and organization values.

9. The system of claim 7, wherein said system is further configured to simulate a game based environment, wherein said game based environment is facilitated by a simulating module.

10. The system of claim 7, wherein said system is further configured to display one or more details, information and suggestions on an interactive dashboard.
